(19) United States
(12) Patent Application Publication
(10) Pub. No.: US 2025/0355388 A1
(43) Pub. Date: Nov. 20, 2025

(54) IMAGE FORMING APPARATUS

(71) Applicant: CANON KABUSHIKI KAISHA, Tokyo (JP)

(72) Inventor: TAKASHI HONKE, Shizuoka (JP)

(21) Appl. No.: 19/200,901

(22) Filed: May 7, 2025

(30) Foreign Application Priority Data
May 14, 2024 (JP) 2024-078790

(51) Int. Cl. G03G 15/20

(52) U.S. Cl. CPC G03G 15/205; G03G 15/2053; G03G 15/2064

(57) ABSTRACT

An image-forming apparatus includes a fixing apparatus configured to fix a toner image onto a recording material, and a controller configured to control fixing of the toner image onto the recording material in accordance with a control condition. The fixing apparatus includes: a fixing member capable of rotating; a pressurizing member configured to, along with the fixing member, nip and convey the recording material; a heating body configured to heat the fixing member; and a measurement circuit configured to measure a temperature of the heating body. The controller is configured to control a supply of power to the heating body using a measured temperature of the heating body measured by the measurement circuit; and change the control condition in a case where the measured temperature is lower than a predicted temperature of the fixing member.

### BACKGROUND OF THE INVENTION

### Field of the Invention

The present disclosure relates to an image-forming apparatus.

### Description of the Related Art

Thus far, many electrophotographic image-forming apparatuses have fixed a toner image to a recording material (also called a “sheet”) by heating and pressurizing the toner image formed on the recording material. For example, Japanese Patent Laid-Open No. 04-44075 discloses an image-forming apparatus including a film-heating type fixing apparatus. The fixing apparatus according to Japanese Patent Laid-Open No. 04-44075 includes a rotatable cylindrical heat-resistant film, a heating body (e.g., a ceramic heater) that heats the heat-resistant film from within, and a pressurizing roller. When the recording material passes through a fixing nip between the heat-resistant film and the pressurizing roller, the toner image formed on the recording material is melted by heat from the heat-resistant film, which is at a high temperature, and is pressurized by the pressurizing roller and fixed to the recording material. The film heating method has an advantage in that using a thin film with low thermal capacity as the fixing member makes it possible to reduce power consumption and shorten the waiting time (enables a quick start).

Temperature control in the fixing apparatus is an important function for achieving stable fixing performance. For example, if the temperature of the fixing member is lower than the required temperature, image defects occur in which the toner does not melt properly and the toner image is not sufficiently fixed to the recording material (called “fixing defects” hereinafter). Conversely, if the temperature of the fixing member is too high, image defects occur in which the viscosity of the toner drops and the toner transfers to the fixing member (called “hot offset” hereinafter).

In general, in an image-forming apparatus that employs the film heating method, it is difficult to directly measure the temperature of the film serving as the thin fixing member. Accordingly, Japanese Patent Laid-Open No. 2020-16731 discloses an image-forming apparatus that predicts the film temperature from the temperature of the heating body, rather than measuring the film temperature directly. The image-forming apparatus according to Japanese Patent Laid-Open No. 2020-16731 predicts the film temperature from a measured temperature of the heating body using a prediction model that models thermal transfer between members including the heating body and the fixing film, and controls the heating of the fixing film during printing operations on the basis of the predicted film temperature.

### SUMMARY OF THE INVENTION

However, whatever prediction model is used to predict the temperature of the fixing member, it is not necessarily the case that the image-forming apparatus will actually be used under the conditions assumed by the prediction model. In particular, the temperature of the film-heating type fixing member is easily affected by external disturbances. For example, there have been situations where when strong airflow different from the assumed conditions is present in the environment in which the image-forming apparatus is installed, the temperature of the fixing member is affected by the airflow and deviates from the predicted temperature, resulting in image defects.

In light of the foregoing, the present disclosure aims to realize a mechanism for reducing the occurrence of image defects in a fixing apparatus.

According to an aspect, there is provided an image-forming apparatus including: a fixing apparatus configured to fix a toner image onto a recording material; and a controller configured to control fixing of the toner image onto the recording material by the fixing apparatus in accordance with at least one control condition. The fixing apparatus includes: a fixing member capable of rotating; a pressurizing member configured to, along with the fixing member, nip and convey the recording material; a heating body configured to heat the fixing member; and a measurement circuit configured to measure a temperature of the heating body. The controller is configured to: control a supply of power to the heating body using a measured temperature of the heating body measured by the measurement circuit; and change the at least one control condition in a case where the measured temperature is lower than a predicted temperature of the fixing member.

Further features of the technology according to the present disclosure will become apparent from the following description of exemplary embodiments (with reference to the attached drawings).

### BRIEF DESCRIPTION OF THE DRAWINGS

FIG. 1 is a schematic diagram illustrating an example of a configuration of an image-forming apparatus according to an embodiment.

FIG. 2 is a schematic diagram illustrating an example of a configuration related to a fixing apparatus illustrated in FIG. 1.

FIG. 3 is a graph for illustrating an example of temporal changes in a fixing temperature prediction result in a conventional example.

FIG. 4 is a graph for illustrating several examples of temporal changes in the actual temperature of a fixing film.

FIG. 5 is a graph for illustrating the effect of airflow on the actual temperature of a fixing film.

FIG. 6 is a graph for illustrating an example of a cause of an image defect when the actual temperature of a fixing film is different from a predicted temperature.

FIG. 7 is a graph for illustrating a relationship between the temperature of a fixing film and the temperature of a heater when no effect of airflow is present, and when the effect of airflow is present.

FIG. 8 is a graph for illustrating a reduction in a predicted temperature of a fixing film when an effect of airflow is present.

FIG. 9 is a flowchart illustrating an example of the flow of temperature monitoring processing according to a first embodiment example.

FIG. 10 is a graph for illustrating the correction of a predicted temperature of a fixing film in a variation.

FIG. 11 is a graph for illustrating the determination of the effect of airflow that is based on a decreasing speed of a measured temperature.

FIG. 12 is a flowchart illustrating an example of the flow of temperature monitoring processing according to a second embodiment example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. Overview of Image-Forming Apparatus

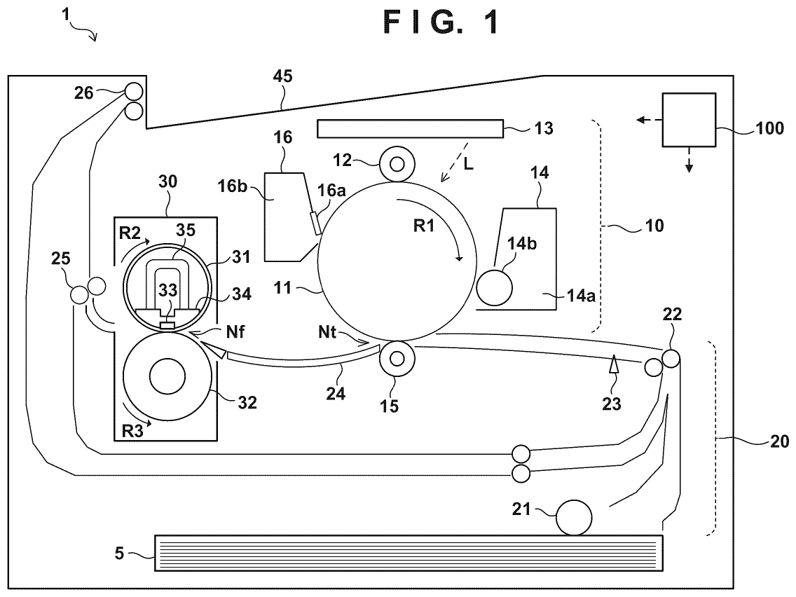

FIG. 1 is a schematic diagram illustrating an example of a configuration of an image-forming apparatus 1 according to an embodiment. The image-forming apparatus 1 is a laser beam printer that forms an image on a recording material using an electrophotographic method. Note that the technology according to the present disclosure is not limited to this example, and may be applied in other types of printers, as well as in other types of image-forming apparatuses, such as photocopiers and multifunction peripherals.

Referring to FIG. 1, the image-forming apparatus 1 includes a cassette 5, an image-forming unit 10, a conveyance unit 20, a fixing apparatus 30, a discharge tray 45, and a control unit 100. The cassette 5 is a container unit that contains recording material in a bundle.

The image-forming unit 10 is an image-forming unit that forms a toner image on a recording material. The image-forming unit 10 includes a photosensitive drum 11, a charging roller 12, an exposure device 13, a developing device 14, a transfer roller 15, and a drum cleaner 16. As an example, the photosensitive drum 11, the charging roller 12, the developing device 14, and the drum cleaner 16 may be included in a process cartridge, which is a component that can be removably mounted to the housing of the image-forming apparatus 1.

The photosensitive drum 11 is a drum-shaped image carrier. The photosensitive drum 11 is driven by a drum drive motor (not shown) to rotate at a predetermined circumferential speed (process speed) in the direction of the arrow R1 in the figure (the clockwise direction). A charging voltage (charging bias) is applied to the charging roller 12, which uniformly charges the surface of the rotating photosensitive drum 11 to a predetermined negative potential, for example. The exposure device 13 may be a laser scanner, for example. The exposure device 13 forms an electrostatic latent image on the surface of the photosensitive drum 11 by scanning the charged surface of the photosensitive drum 11 with a laser beam modulated according to input image data. This removes the charge from the parts of the surface of the photosensitive drum 11 exposed to the laser beam. The developing device 14 includes a toner containing unit 14a and a developing roller 14b. The toner containing unit 14a contains toner, which is a developing agent, therein. A developing voltage (a developing bias) is applied to the developing roller 14b, which supplies the toner contained in the toner containing unit 14a to the rotating photosensitive drum 11, and the electrostatic latent image on the surface of the photosensitive drum 11 is developed (visualized) to form a toner image (a developing agent image) as a result. At this time, the toner carried by the developing roller 14b takes on a negative charge, for example, due to friction with a regulating member (not shown), and adheres to the photosensitive drum 11 due to the potential difference between the developing roller 14b and the photosensitive drum 11. The transfer roller 15 is arranged opposite the photosensitive drum 11 at a transfer nip Nt, and is biased toward the photosensitive drum 11. If no recording material is present, the transfer roller 15 makes contact with the photosensitive drum 11 at the transfer nip Nt. The photosensitive drum 11 carries the toner image to convey the toner image from a developing position to the transfer nip Nt.

The conveyance unit 20 is a conveyance unit that conveys the recording material along a conveyance path. The conveyance unit 20 includes a feed roller 21, a first conveyance roller pair 22, a top sensor 23, a guide 24, a second conveyance roller pair 25, and a discharge roller pair 26. The feed roller 21 picks up one piece of the recording material at a time from the recording material bundle in the cassette 5 and feeds that recording material to the conveyance path. The first conveyance roller pair 22 feeds the recording material into the transfer nip Nt in accordance with the timing at which the toner image on the surface of the photosensitive drum 11 reaches the transfer nip Nt. The top sensor 23 detects the leading end of the recording material and outputs a detection signal to the control unit 100. The control unit 100 controls the conveyance of the recording material by the first conveyance roller pair 22 on the basis of the detection signal from the top sensor 23.

At the transfer nip Nt, the toner image on the surface of the photosensitive drum 11 is transferred onto the recording material which is nipped by the photosensitive drum 11 and the transfer roller 15 and conveyed in that state. At this time, a transfer voltage (a transfer bias) having a polarity (e.g., positive) opposite from the polarity of the toner (e.g., negative) is applied to the transfer roller 15. The toner image is transferred onto the recording material due to the potential difference with the transfer voltage. The drum cleaner 16 includes a cleaning blade 16a and a waste toner receptacle 16b. The cleaning blade 16a wipes toner remaining on the surface of the photosensitive drum 11 (waste toner) and collects the waste toner into the waste toner receptacle 16b. The waste toner is accumulated in the waste toner receptacle 16b.

The fixing apparatus 30 is a fixing unit that fixes the toner image formed on the recording material onto the recording material. The recording material onto which the toner image has been transferred is conveyed along the guide 24 and fed into a fixing nip Nf of the fixing apparatus 30. In the example in FIG. 1, the fixing apparatus 30 includes a fixing film 31, a pressurizing roller 32, a heater 33, a heater holder 34, and a stay 35. The fixing film 31 is a flexible, endless fixing member that can rotate in the direction of the arrow R2 in the figure. The pressurizing roller 32 is arranged opposite the fixing film 31 at the fixing nip Nf, and is biased toward the fixing film 31. The pressurizing roller 32 is driven by a fixing drive motor (not shown) to rotate in the direction of the arrow R3 in the figure, and conveys the recording material that has reached the fixing nip Nf, along with the fixing film 31, in a nipped state. The heater 33 is a heating body that heats the fixing film 31. The heater 33 is arranged in a space surrounded by the fixing film 31, and nips the fixing film 31 at the fixing nip Nf between the heater 33 and the pressurizing roller 32. The heater holder 34 holds the heater 33. The stay 35 supports the heater holder 34 in a fixed manner. The toner of the toner image formed on the recording material is melted by being heated through the fixing film 31 at the fixing nip Nf, and is pressurized by the pressurizing roller 32 to adhere to the recording material. The toner image is fixed on the recording material as a result. An example of the configuration of the fixing apparatus 30 will be described in further detail below.

The second conveyance roller pair 25 conveys the recording material that has passed through the fixing nip Nf downstream in the conveyance path. The discharge roller pair 26 discharges the recording material to the discharge tray 45, which is located on an upper surface of the housing of the image-forming apparatus 1.

The control unit 100 is a controller that controls the overall operations of the image-forming apparatus 1 described above. The control unit 100 may include a memory that stores computer programs and various data, processing circuitry that executes the computer programs, an input/output interface for inputting/outputting signals, and a communication interface for communicating with external apparatuses, for example. The memory may include any combination of non-volatile and volatile types of storage media, such as read-only memory (ROM) and random access memory (RAM), for example. The processing circuitry may include one or more central processing units (CPUs), for example. For example, when a print job is received from an external host computer, the control unit 100 controls the image-forming unit 10, the conveyance unit 20, and the fixing apparatus 30 to form an image on recording material on the basis of image data included in the received print job. As an example, the image-forming apparatus 1 may be a high-speed machine capable of forming an image on A4-sized recording material at a rate of 70 sheets per minute.

### 2. Details of Fixing Apparatus

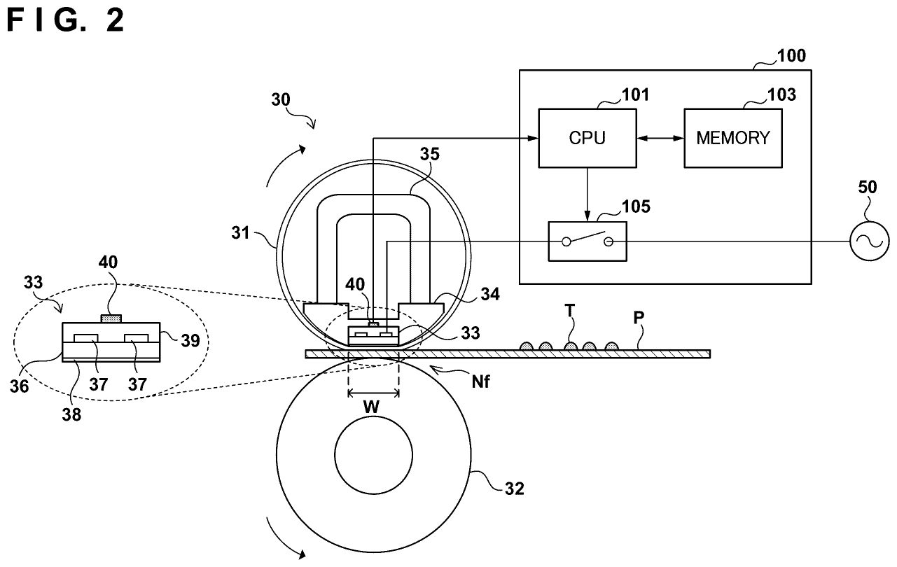

FIG. 2 is a schematic diagram illustrating an example of a configuration related to the fixing apparatus 30 illustrated in FIG. 1. FIG. 2 schematically illustrates an example of a configuration in which a cross-section of the fixing apparatus 30 is viewed from the direction of the axis of rotation of the pressurizing roller 32, and illustrates recording material P passing through the fixing nip Nf along with unfixed toner T as well as an example of a connection relationship between the fixing apparatus 30 and the control unit 100. An example of the configuration of the heater 33 of the fixing apparatus 30 is also illustrated in detail, in an enlarged manner.

### 2-1. Fixing Member

The fixing film 31 is a cylindrical film extending in what is the depth direction in the figure. The fixing film 31 is loosely fitted over the outside of the heater holder 34. The heater 33 is held by the heater holder 34 by fitting into a recess formed in a lower part of the heater holder 34. At the fixing nip Nf, an inner surface of the fixing film 31 makes contact with a bottom surface of the heater 33 and a bottom surface (around the recess) of the heater holder 34 over a width W, so as to be capable of sliding thereon. Because the heater holder 34 is fixedly supported by the stay 35, the heater holder 34 will not rotate, and the heater 33 will not move, even if the fixing film 31 rotates in response to the pressurizing roller 32 rotating and the recording material P being conveyed. The heater holder 34 acts as a guide member that guides the fixing film 31 to the fixing nip Nf.

The fixing film 31 has a structure in which, for example, a base layer, an elastic layer, and a surface layer are laminated in that order from the inside to the outside. The base layer is formed of a highly heat-resistant resin material such as polyimide (PI), polyamide-imide (PAI), polyether ether ketone (PEEK), or polyether sulfone (PES), for example. The thickness of the base layer is selected so as to achieve both sufficient mechanical strength and low thermal capacity to ensure good quick start performance. For example, the thickness of the base layer may be in the range of 18 to 150 micrometers (μm), preferably in the range of 30 to 100 μm, and more preferably in the range of 50 to 80 μm. The base layer may be made electrically conductive by adding carbon as an electron conductive agent (or a metal complex as an ion conductive agent). The elastic layer may be formed of highly heat-resistant silicon rubber or fluororubber, for example, and may be made electrically conductive by adding carbon as an electron conductive agent. The elastic layer may be made highly thermally conductive by adding an inorganic material such as ceramic powder, metal oxide powder, or metal powder (e.g., alumina, metallic silicon, silicon carbide, or zinc oxide) as a thermally-conductive filler. For example, a thermal conductivity of at least 0.9 W/m·K for the elastic layer is suitable for high-speed machines. From the standpoint of the heating efficiency of the fixing performance, the thickness of the elastic layer may be in the range of, for example, 30 to 500 μm, preferably in the range of 100 to 400 μm, and more preferably in the range of 200 to 300 μm. The surface layer, which acts as a release layer, requires high releasability and high resistance to wear with respect to toner. For example, the surface layer may be formed as a coating layer obtained by firing a fluorine resin dispersion, or as a tube layer formed from fluorine resin. The surface layer may be made electrically conductive by adding carbon as an electron conductive agent (or a metal complex as an ion conductive agent). From the standpoint of releasability, resistance to wear, and heating efficiency, the thickness of the surface layer may be in the range of, for example, 1 to 50 μm, preferably in the range of 5 to 40 μm, and more preferably in the range of 10 to 30 μm. The heater holder 34 is formed of a highly heat-resistant resin material, such as a liquid-crystal polymer (LCP), phenolic resin, polyphenylene sulfide (PPS), PEEK, or the like, for example.

### 2-2. Heating Body

As illustrated in an enlarged manner in FIG. 2, the heater 33 includes a heater base plate 36, a resistance pattern 37, an overcoat glass 38, and an insulating layer 39. The heater base plate 36 is a highly heat-resistant board made of a ceramic material such as aluminum nitride or alumina, for example. The heater base plate 36 may be formed from a metal material rather than a ceramic material. The resistance pattern 37 is a pattern of heat-producing resistance layers formed on an upper surface of the heater base plate 36. The resistance pattern 37 is connected to a power source via a switching element 105 (described below). When the switching element 105 is turned on and current flows in the resistance pattern 37, the resistance pattern 37 produces heat. The overcoat glass 38 is a flat plate-like protective member that is electrically insulative and resistant to wear, and that covers the bottom surface of the heater base plate 36. The insulating layer 39 protects the resistance pattern 37 on the upper surface of the heater base plate 36.

In the present embodiment, a thermistor 40 is arranged in the vicinity of the heater 33, and more specifically, on the upper surface of the heater 33 (the surface on the side opposite from the surface that makes contact with the fixing film 31). The thermistor 40 is a measurement circuit that measures the temperature of the heater 33. The thermistor 40 outputs a signal indicating the measured temperature of the heater 33 to the control unit 100.

### 2-3. Pressurizing Member

The pressurizing roller 32 is constituted by a core shaft, a cylindrical elastic layer surrounding the core shaft, and a surface layer covering the surface of the elastic layer, for example. The core shaft may be a solid cylindrical member or a hollow cylindrical member formed of a metal material such as aluminum, an aluminum alloy, or iron, for example. The elastic layer of the pressurizing roller 32 may be formed of highly heat-resistant silicon rubber, for example, and may be made electrically conductive by adding carbon as an electron conductive agent. The surface layer of the pressurizing roller 32 may be formed of a fluorine resin, for example, and may also be made electrically conductive by adding carbon as an electron conductive agent (or a metal complex as an ion conductive agent). Making the elastic layer and the surface layer conductive makes it possible to suppress charging up of the pressurizing roller 32 arising when the recording material on which a toner image is formed passes through the fixing nip Nf.

Although not illustrated in FIG. 2, the core shaft of the pressurizing roller 32 includes, at an end thereof, a drive gear that receives drive force from the fixing drive motor. When the fixing drive motor rotates under the control of the control unit 100, the pressurizing roller 32 rotates as well. The rotation of the pressurizing roller 32 is transmitted to the fixing film 31 by frictional force produced between the fixing film 31 and the pressurizing roller 32 at the fixing nip Nf. As a result, the fixing film 31 rotates around the heater holder 34 and the stay 35 while sliding against the bottom surface of the heater 33 and the heater holder 34.

### 3. Control of Fixing Temperature

The control unit 100 controls the fixing of the toner image to the recording material P by the fixing apparatus 30 in accordance with at least one control condition. The control conditions for the fixing control include the amount of heat generated by the heater 33 during fixing operations, for example. The switching element 105 is provided in a power supply line from a power source 50 (e.g., a commercial power source) to the heater 33 in order to control the amount of heat generated by the heater 33. The switching element 105 may be a TRIAC, for example. When a CPU 101 switches the switching element 105 on, power is supplied from the power source 50 to the heater 33, the resistance pattern 37 of the heater 33 generates heat, and the heater 33 heats the fixing film 31. When the CPU 101 switches the switching element 105 off, the supply of power from the power source 50 to the heater 33 is cut off. Examples of other control conditions for fixing control will be described below.

As described above, appropriately controlling the temperature of the fixing film 31 (called the “fixing temperature” hereinafter) during the fixing operations is important for achieving stable fixing performance. The fixing temperature may be controlled by adjusting the duty ratio of the switching element 105 through typical feedback control based on the difference between a current temperature and a target temperature. However, in the image-forming apparatus 1, which uses the film heating method, it is difficult to directly measure the fixing temperature at the fixing nip Nf. Accordingly, in the present embodiment, the CPU 101 predicts the current fixing temperature using the measured temperature of the heater 33 as measured by the thermistor 40, and controls the supply of power to the heater 33 on the basis of the predicted temperature.

### 3-1. Predicting Fixing Temperature

The CPU 101 may predict the current fixing temperature by inputting the measured temperature of the heater 33 to any publicly-known prediction model. As an example, the prediction model described in Japanese Patent Laid-Open No. 2020-16731 is constituted by a set of several relational expressions that model thermal transfer between members including the heating body and the fixing film. Applying this to the example configuration in FIG. 2, the temperature of the heater 33 affects the temperature of the fixing film 31 and the heater holder 34 after one control cycle passes. If power is supplied to the heater 33 during that control cycle, the heater 33 generates heat in accordance with the amount of power newly received. The temperature of the fixing film 31 affects the temperature of the recording material P or the pressurizing roller 32, the heater 33, and the heater holder 34. The temperature of the heater holder 34 affects the temperature of the fixing film 31, the heater 33, and the stay 35. As such, if the effects of the temperature of respective members on the temperature of other members after one control cycle passes are defined by relational expressions having predetermined sets of coefficients, the temperature of each member at a later point in time can be predicted on the basis of the temperature of the members at a given point in time. At this time, in addition to the effects of the temperature of other members, rise in temperature caused by newly-generated heat is also factored into the determination of the temperature of the heater 33. Of course, other parameters such as the process speed, the rotational speed of the roller, the area ratio (printing ratio) of the toner T, or the ambient temperature may further be factored into the relational expressions. A memory 103 stores the prediction model constituted by such a set of relational expressions. For example, a state in which the temperature of all members is the same as the ambient temperature is assumed to be an initial state of the prediction. Then, for each control cycle, the CPU 101 predicts the temperature of the fixing film 31 (and the temperature of other members) by inputting the measured temperature of the heater 33 and the amount of power supplied to the heater 33 (as well as other desired parameters) into the prediction model. Repeating this processing over a plurality of control cycles makes it possible to continuously predict the temperature of the fixing film 31, which changes over time.

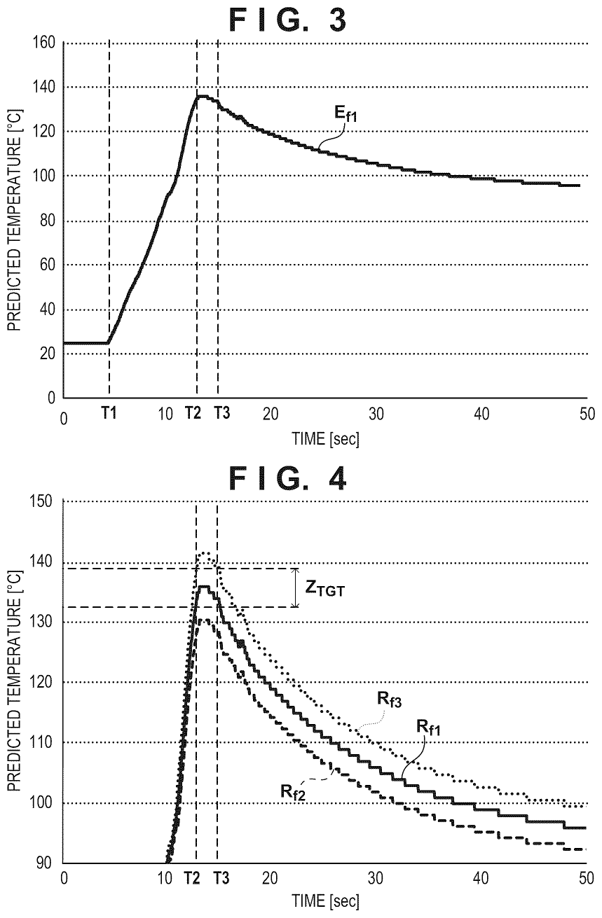

FIG. 3 is a graph for illustrating an example of temporal changes in a fixing temperature prediction result in a conventional example. The horizontal axis of the graph represents the passage of time in seconds, and the vertical axis represents the predicted temperature in degrees Celsius. In FIG. 3, a predicted temperature profile E_{f1} representing the fixing temperature prediction result is plotted. According to the predicted temperature profile E_{f1}, in response to receiving the print job, the CPU 101 starts supplying power from the power source 50 to the heater 33 at time T1. Upon doing so, the predicted temperature rises rapidly. At time T2, the leading end of the recording material P on which the toner image has been formed reaches the fixing nip Nf, and at time T3, the trailing end of the recording material P separates from the fixing nip Nf. From time T2 to time T3, the predicted temperature levels off and then decreases slightly thereafter. After time T3, the CPU 101 stops the supply of power to the heater 33, and the predicted temperature decreases due to natural cooling.

### 3-2. Fixing Performance

In the predicted temperature profile E_{f1}, if the predicted temperature of the fixing film 31 in the period where the recording material P passes the fixing nip Nf (called a “fixing period” hereinafter) falls within a target range and there is no prediction error, the expected fixing performance will likely be achieved. In the example illustrated in FIG. 3, the fixing period is the period from time T2 to time T3.

FIG. 4 is a graph for illustrating several examples of temporal changes in the actual temperature of the fixing film 31. In FIG. 4, three actual temperature profiles R_{f1}, R_{f2}, and R_{f3} are plotted, and a desired fixing temperature range (target temperature range) Z_{TGT} is furthermore illustrated. In the example in FIG. 4, the target temperature range Z_{TGT} is in a range of about 133° C. to 138° C. According to the actual temperature profile R_{f1}, the actual temperature of the fixing film 31 falls within the target temperature range Z_{TGT} throughout the fixing period. On the other hand, according to the actual temperature profile R_{f2}, the actual temperature of the fixing film 31 is below the target temperature range Z_{TGT} throughout the fixing period. In this case, the toner T will not melt properly, and the toner image will not be sufficiently fixed to the recording material P. In other words, a fixing defect occurs. Meanwhile, according to the actual temperature profile R_{f3}, the actual temperature of the fixing film 31 is above the target temperature range Z_{TGT} throughout the fixing period. In this case, the viscosity of the melted toner T drops, and the toner is transferred to the fixing film 31, i.e., hot offset occurs.

The deviation of the fixing temperature from the target temperature described above is caused by error in the prediction of the fixing temperature. For example, if the predicted temperature at the start of image-forming operations is significantly higher than the actual temperature, the difference between the target temperature and the predicted temperature becomes too small, and not enough power is supplied to the heater 33 to raise the temperature of the fixing film 31 to the target temperature by time T2. As a result, the fixing temperature during the fixing period will be below the target temperature range Z_{TGT}, as in the actual temperature profile R_{f2}. Conversely, if the predicted temperature at the start of image-forming operations is significantly lower than the actual temperature, the difference between the target temperature and the predicted temperature becomes too great. As a result, too much power is supplied to the heater 33 by time T2, and the fixing temperature during the fixing period rises above the target temperature range Z_{TGT}, as in the actual temperature profile R_{f3}.

### 3-3. Effect of Airflow

Whatever prediction model is used to predict the temperature of the fixing member, it is not necessarily the case that the image-forming apparatus will actually be used under the conditions assumed by the prediction model. In particular, in the film heating method, the temperature of the fixing member is easily affected by external disturbances. For example, when strong airflow different from the assumed conditions is present in the environment in which the image-forming apparatus is installed, the temperature of the fixing member is more likely to be affected by the airflow and deviate from the predicted temperature. Deviation of the actual temperature of the fixing member from the predicted temperature causes image defects such as fixing defects and hot offset, as described with reference to FIG. 4.

For example, a given prediction model takes, as an assumed condition, that the temperature of the fixing member drops due to natural cooling after the image-forming operations end. In the prediction model described in Japanese Patent Laid-Open No. 2020-16731, this assumed condition is reflected in the coefficients of relational expressions representing state transitions of the temperature of the members. However, in the actual installation environment of the image-forming apparatus, external devices which produce airflow are often present, such as air conditioners or ceiling fans, for example. When airflow from such an external device flows into the image-forming apparatus from an opening in the housing of the apparatus, the temperature of the fixing member drops more rapidly than in the case of natural cooling. In other words, the airflow from the external device acts as an external disturbance on the conditions assumed by a predetermined prediction model (e.g., determined in the manufacturing stage of the apparatus), and affects the temperature of the fixing member.

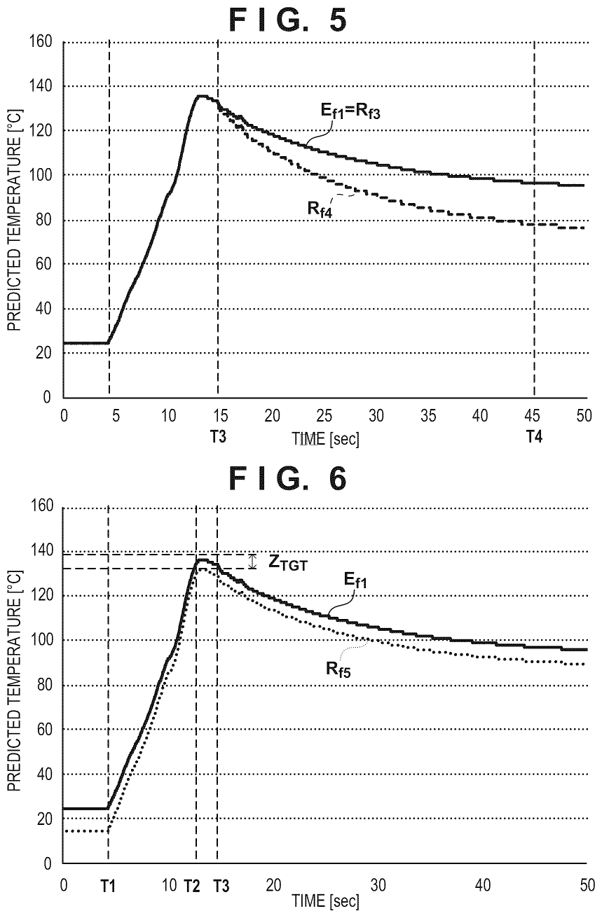

FIG. 5 is a graph for illustrating the effect of airflow on the actual temperature of the fixing film 31. FIG. 5 illustrates actual temperature profiles R_{f3} and R_{f4} along with the same predicted temperature profile E_{f1} as that illustrated in FIG. 3. Note that the temporal change in the actual temperature of the fixing film 31 can be obtained experimentally by measuring the surface temperature of the fixing film 31 at a set interval of time using a non-contact thermometer (e.g., a radiation thermometer) installed at a position immediately after the fixing nip Nf.

The actual temperature profile R_{f3} represents a temporal change in the actual temperature of the fixing film 31 when no effect of airflow is present, and the fixing film 31 cools naturally after the image-forming operations end at time T3. The actual temperature profile R_{f3} almost matches the predicted temperature profile E_{f1}, which means that there is almost no prediction error.

On the other hand, the actual temperature profile R_{f4} represents a temporal change in the actual temperature of the fixing film 31 when the temperature of the fixing film 31 is affected by airflow, and the temperature of the fixing film 31 drops more rapidly after the image-forming operations end. The actual temperature profile R_{f4} gradually deviates from the predicted temperature profile E_{f1} after time T3, and at time T4, when 30 seconds have passed from time T3, the difference has reached about 20° C., for example. In other words, at time T4, the predicted temperature of the fixing film 31 is about 20° C. higher than the actual temperature. This may cause fixing defects in print jobs to be executed thereafter.

FIG. 6 is a graph for illustrating an example of a cause of an image defect when the actual temperature of the fixing film 31 is different from the predicted temperature. FIG. 6 illustrates an actual temperature profile R_{f5} along with the same predicted temperature profile E_{f1} as that illustrated in FIG. 3. The actual temperature profile R_{f5} represents a temporal change in the actual temperature of the fixing film 31 when the predicted temperature of the fixing film 31 is 10° C. higher than the actual temperature at time T1 when the image-forming operations start. Under the conditions of the actual temperature profile R_{f5}, at the start of image-forming operations, the difference between the actual temperature of the fixing film 31 and the target temperature is 10° C. greater than the difference between the predicted temperature and the target temperature. Nevertheless, because the difference is predicted to be small, enough power (or enough heating time) to raise the actual temperature of the fixing film 31 to the target temperature is not provided to the heater 33. As a result, the actual temperature of the fixing film 31 during the fixing period is lower than the target temperature range Z_{TGT}.

Since it is impossible to know, when the image-forming apparatus is manufactured, whether or not an external device that produces airflow will be present in the actual installation environment of the image-forming apparatus, incorporating the effect of airflow into the prediction model in advance is unrealistic. Accordingly, in the present embodiment, the CPU 101 determines whether the temperature of the fixing film 31 is being affected by airflow on the basis of the measured temperature of the heater 33 as measured by the thermistor 40. Then, when it is determined that the temperature of the fixing film 31 will be affected by airflow, the CPU 101 changes at least one control condition for controlling the fixing of the toner image to the recording material by the fixing apparatus 30 from a condition used when no effect of airflow is present. This compensates for the effect of airflow and reduces the occurrence of image defects. Several embodiment examples of such control will be described in detail in the following sections.

### 4. First Embodiment Example

### 4-1. Determining Effect of Airflow

In the first embodiment example, the CPU 101 derives the predicted temperature of the fixing film 31 by inputting the measured temperature of the heater 33 to the above-described prediction model stored in the memory 103. The temperature of the heater 33 is measured by the thermistor 40. The fixing apparatus 30 does not include a temperature measurement circuit for predicting the temperature of the fixing film 31 (e.g., a temperature sensor that directly measures the temperature of the fixing film 31) aside from the thermistor 40. This makes it easier to reduce the size and cost of the fixing apparatus 30. The CPU 101 controls the supply of power from the power source 50 to the heater 33 such that the temperature of the fixing film 31 falls within the target temperature range during the fixing period using the predicted temperature of the fixing film 31 as a control variable for feedback control.

The CPU 101 monitors the measured temperature of the heater 33 to determine whether the temperature of the fixing film 31 is being affected by airflow. Specifically, in the first embodiment example, when the measured temperature of the heater 33 is lower than a first threshold which is based on the predicted temperature of the fixing film 31, the CPU 101 determines that the temperature of the fixing film 31 is being affected by airflow. The first threshold is equal to the sum of the predicted temperature of the fixing film 31 and a predetermined offset. Note that the offset may alternatively be zero, in which case the first threshold is equal to the predicted temperature of the fixing film 31.

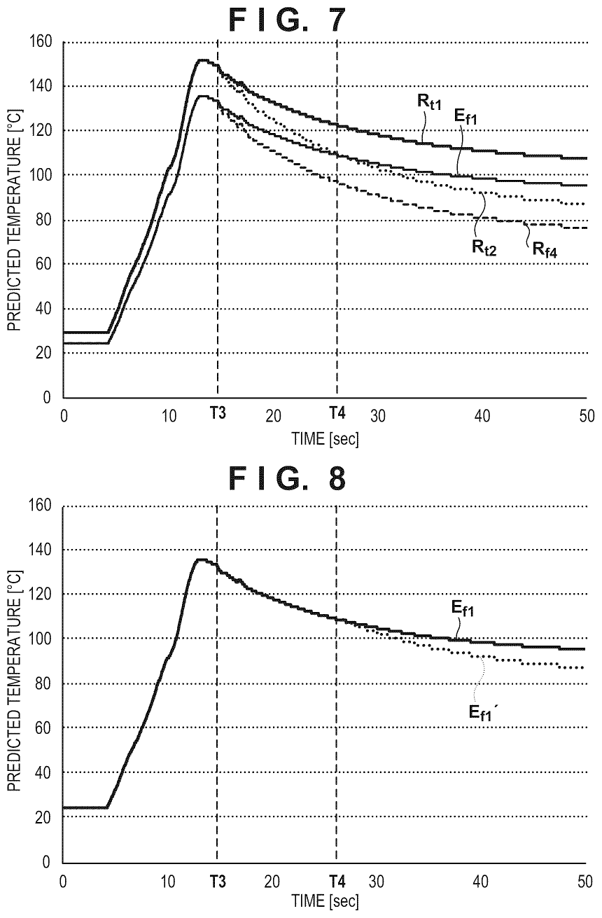

FIG. 7 is a graph for illustrating a relationship between the temperature of the fixing film and the temperature of the heater when no effect of airflow is present, and when the effect of airflow is present. FIG. 7 illustrates measured temperature profiles Rₜ₁ and Rₜ₂ of the heater 33, and the actual temperature profile R_{f4} of the fixing film 31, along with the same predicted temperature profile E_{f1} as that illustrated in FIG. 3. The measured temperature profile Rₜ₁ represents a temporal change in the measured temperature of the heater 33 as measured directly by the thermistor 40, when no effect of airflow is present. The predicted temperature profile E_{f1} represents a temporal change in the predicted temperature of the fixing film 31 predicted on the basis of the measured temperature profile Rₜ₁. Because the heater 33 generates heat on its own when energized and provides that heat to the fixing film 31, the measured temperature profile Rₜ₁ indicates a value higher than the predicted temperature profile E_{f1} throughout the period indicated in the figure.

The measured temperature profile Rₜ₂ represents a temporal change in the measured temperature of the heater 33 as measured directly by the thermistor 40, when the effect of airflow is present. When the effect of airflow is present, the temperature of the fixing film 31 is expected to drop in the same manner as the temperature of the heater 33. The actual temperature profile R_{f4} represents a temporal change in the actual temperature of the fixing film 31.

According to the measured temperature profile Rₜ₂, the measured temperature of the heater 33 drops more rapidly than the temperature of the heater 33 (the measured temperature profile Rₜ₁) during natural cooling when no effect of airflow is present, after time T3; the measured temperature of the heater 33 then converges with the predicted temperature of the fixing film 31 at time T4. From time T4, the measured temperature of the heater 33 indicated by the measured temperature profile Rₜ₂ is lower than the predicted temperature of the fixing film 31 indicated by the predicted temperature profile E_{f1}. Accordingly, by setting the predicted temperature or the sum of the predicted temperature and the predetermined offset as the first threshold, and comparing the measured temperature of the heater 33 with the first threshold, the CPU 101 can simply determine whether the temperature of the fixing film 31 is being affected by airflow. For example, when the offset is zero and the measured temperature of the heater 33 drops as per the measured temperature profile Rₜ₂, the CPU 101 determines that the temperature of the fixing film 31 is being affected by airflow at time T4.

### 4-2. Changing Control Conditions

When it is determined that the temperature of the fixing film 31 is being affected by airflow, the CPU 101 changes at least one control condition for controlling the fixing by the fixing apparatus 30. In the present embodiment example, changing at least one control condition includes increasing the amount of heat generated by the heater 33 per unit of time. The CPU 101 can increase the amount of heat generated by the heater 33 per unit of time by one or more of (i) lowering the control variable of the feedback control (the predicted temperature of the fixing film 31), (ii) raising a target value, and (iii) increasing a gain, for example. As a simple example, the predicted temperature, serving as a control variable of the feedback control, may be lowered to a value equal to the measured temperature of the heater 33. FIG. 8 is an explanatory diagram illustrating the lowering of the predicted temperature in this manner. FIG. 8 illustrates a post-change predicted temperature profile E_{f1}′ along with the same predicted temperature profile E_{f1} as that illustrated in FIG. 7. The predicted temperature profile E_{f1}′ matches the predicted temperature profile E_{f1} up to time T4, when it is determined that the effect of airflow is present, and matches the measured temperature profile Rₜ₁ indicated in FIG. 7 from time T4 on. In other words, after time T4, the predicted temperature is lowered to the measured temperature of the heater 33 in the case of the effect of airflow being present. By adjusting the parameters of the feedback control in this manner, power is supplied to the heater 33 at a higher duty ratio at the start of the next round of image-forming operations, and the amount of heat generated per unit of time is increased. In this manner, the temperature of the fixing film 31 rises more rapidly, whereby the possibility of the temperature of the fixing film 31 deviating from the target temperature range during the fixing period is reduced.

### 4-3. Flow of Processing

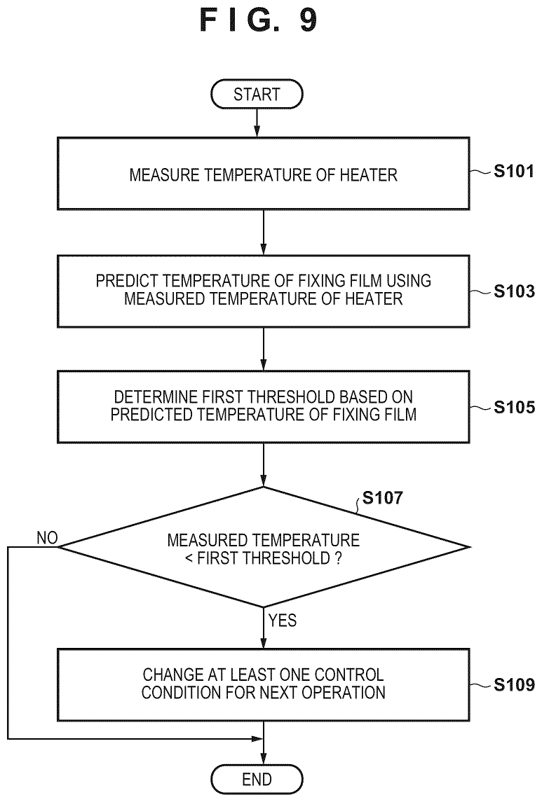

FIG. 9 is a flowchart illustrating an example of the flow of temperature monitoring processing according to the first embodiment example. The temperature monitoring processing illustrated in FIG. 9 can be executed iteratively by the control unit 100 in a constant monitoring cycle during a period when the image-forming apparatus 1 is not performing image-forming operations, for example.

First, in step S101, the control unit 100 causes the thermistor 40 arranged near the heater 33 to measure the temperature of the heater 33, and obtains the measured temperature. Next, in step S103, the control unit 100 predicts the current temperature of the fixing film 31 by inputting the measured temperature of the heater 33 to a predefined prediction model. Then, in step S105, the control unit 100 determines a first threshold for determining the effect of airflow on the basis of the predicted temperature of the fixing film 31. As described above, the first threshold may be equal to the predicted temperature, or may be the sum of the predicted temperature and the predetermined offset.

Next, in step S107, the control unit 100 determines whether the measured temperature of the heater 33 obtained in step S101 is lower than the first threshold determined in step S105. If the measured temperature of the heater 33 is determined to be lower than the first threshold, in step S109, the control unit 100 changes at least one control condition to be used during the next round of fixing operations. Step S109 is skipped if the measured temperature of the heater 33 is determined not to be lower than the first threshold.

Note that if the control conditions to be used during the next round of fixing operations are changed in step S109, the temperature monitoring processing in the subsequent monitoring cycles may be omitted, and the post-change control conditions may be kept until the next round of fixing operations.

### 4-4. Comparative Test

To confirm the effects of the first embodiment example, a comparative test was performed to compare the fixing performance in the first embodiment example and two comparison examples. The configurations of the members of the fixing apparatus 30 were the same in the first embodiment example and the comparison examples. The main characteristics of the fixing film 31 and the pressurizing roller 32 were as follows:

### Fixing Film

Outer diameter: approx. 24 [mm]
Base layer material: PI with conductive agent added
Base layer thickness: approx. 70 [μm]
Elastic layer material: silicon rubber with alumina and metallic silicon added as thermally-conductive filler
Thermal conductivity of elastic layer: 1.5 [W/m·K]
Elastic layer thickness: approx. 270 [μm]
Surface layer material: tetrafluoroethylene/perfluoro alkyl vinyl ether copolymer (PFA)
Surface layer thickness: approx. 25 [μm]
Fixing nip width (W in FIG. 2): 9 [mm]

### Pressurizing Roller

Outer diameter: approx. 25 [mm]
Core shaft material: aluminum
Elastic layer material: silicon rubber with conductive agent added
Surface layer material: PFA with conductive agent added
Surface layer thickness: approx. 30 [μm]
Surface layer electrical resistance: approx. 105 [Ω/cm²]
Applied pressure: 186.2 [N] (=19 [kgf])

The other main test conditions are as follows:

### Test Environment

Ambient temperature: 15[° C.]
Ambient humidity (relative humidity): 10[%]

### Recording Material Used

Product: CS-068, Canon Marketing Japan
Size: A4
Basis weight: 68 [g/cm²]

In the first embodiment example, after the temperature of the fixing film 31 is determined to be affected by airflow using a first threshold equal to the predicted temperature of the fixing film 31, the predicted temperature of the fixing film 31 is changed as per the post-change predicted temperature profile E_{f1}′ indicated in FIG. 8. On the other hand, in the two comparison examples, the effect of airflow is not determined, and thus the predicted temperature of the fixing film 31 changes as per the predicted temperature profile E_{f1} indicated in FIG. 3.

Additionally, in the first embodiment example and the first comparison example, when the predicted temperature at the start of image-forming operations is 15° C. and 25° C., the target value of the temperature control is set to 165° C. and 155° C., respectively. On the other hand, in the second comparison example, the target value of the temperature control is set to 165° C. regardless of the predicted temperature at the start of image-forming operations. The predicted temperature profiles and temperature control target values corresponding to the first embodiment example, the first comparison example, and the second comparison example are summarized in the following Table 1.

TABLE 1

| | | TEMPERATURE CONTROL | |
|---|---|---|---|
| | | TARGET VALUE [° C.] | |
| | PREDICTED | STARTING | STARTING |
| | TEMPER- | TEMPER- | TEMPER- |
| | ATURE | ATURE | ATURE |
| | PROFILE | 15 [° C.] | 25 [° C.] |
| FIRST | E_{f1}′ (SUBJECT | 165 | 155 |
| EMBODIMENT | TO CHANGE) | | |
| EXAMPLE | | | |
| FIRST | E_{f1} | 165 | 155 |
| COMPARISON | | | |
| EXAMPLE | | | |
| SECOND | E_{f1} | 165 | 165 |
| COMPARISON | | | |
| EXAMPLE | | | |

For each of the first embodiment example, the first comparison example, and the second comparison example, the temperature of the fixing film 31 was changed according to the following two scenarios, and the fixing performance of each was then subjectively evaluated:
A) Natural cooling for 30 minutes after printing an image on 10 sheets of recording material
B) Cooling the fixing film 31 with airflow from an external fan after printing an image on 10 sheets of recording material

In scenario A, the actual temperature of the fixing film 31 was 25° C. even after natural cooling for 30 minutes, which was 10° C. higher than the ambient temperature of 15° C. On the other hand, in scenario B, the actual temperature of the fixing film 31 dropped to 15° C., which is the same as the ambient temperature, after cooling for 30 minutes.

The following Table 2 lists the evaluation results. A circle in the table indicates that no image defects (fixing defects or hot offset) that would pose a problem in practice occurred. An X, meanwhile, indicates that an image defect that would pose a problem in practice occurred.

TABLE 2

| | NOT AFFECTED BY | | AFFECTED BY | |
|---|---|---|---|---|
| | OUTSIDE AIR | | OUTSIDE AIR | |
| | (SCENARIO A) | | (SCENARIO B) | |
| | FIXING | HOT | FIXING | HOT |
| | DEFECT | OFFSET | DEFECT | OFFSET |
| FIRST | ◯ | ◯ | ◯ | ◯ |
| EMBODIMENT | | | | |
| EXAMPLE | | | | |
| FIRST | ◯ | ◯ | X | ◯ |
| COMPARISON | | | | |
| EXAMPLE | | | | |
| SECOND | ◯ | X | ◯ | ◯ |
| COMPARISON | | | | |
| EXAMPLE | | | | |

In the first comparison example, image defects did not occur in scenario A, which is the case of no effect of outside air being present, but fixing defects did occur in scenario B, which is the case of the effect of outside air being present. The reason why fixing defects occurred in scenario B is that, since the predicted temperature of the fixing film 31 at the start of image-forming operations was 25° C., the target value of the temperature control was set to 155° C., but the actual temperature at the start was 15° C., i.e., 10° C. lower than the predicted temperature. In this case, the heater 33 cannot generate sufficient heat by the fixing period, and the temperature of the fixing film 31 would not reach the target temperature range.

In the second comparison example, image defects did not occur in scenario B, which is the case of the effect of outside air being present, but hot offset did occur in scenario A, which is the case of no effect of outside air being present. The reason why hot offset occurred in scenario A is that, since the predicted temperature of the fixing film 31 at the start of image-forming operations was 25° C., the target value of the temperature control was set to 165° C., but this target value was too high. In this case, the heater 33 generated too much heat by the fixing period, and the temperature of the fixing film 31 exceeded the target temperature range as a result.

In contrast, in the first embodiment example, image defects occurred in neither scenario A nor scenario B. The reason why hot offset did not occur in scenario A is that the predicted temperature of the fixing film 31 at the start of image-forming operations was 25° C., with no error relative to the actual temperature, and the value of 155° C. was therefore appropriate as the target value of the temperature control. The reason why fixing defects did not occur in scenario B is that the predicted temperature at the start of image-forming operations was 10° C. higher than the actual temperature, but the amount of heat generated by the heater 33 was increased in response to the determination that the effect of outside air was present.

### 4-5. Changing Control Conditions (Variations)

Although the present embodiment example has mainly described where the amount of heat generated by the heater 33 during fixing operations is increased as an example of changing at least one control condition, the present embodiment example is not limited thereto.

In a first variation, the CPU 101 may, in response to a determination that the temperature of the fixing film 31 is being affected by airflow, extend the time from when the supply of power to the heater 33 is started to when the recording material reaches the fixing nip Nf (called a “preheating time” hereinafter). For example, the CPU 101 can delay the timing at which the recording material is fed by the feed roller 21 to extend the preheating time.

In a second variation, when toner images are successively formed on a plurality of recording materials, the CPU 101 may, in response to a determination that the temperature of the fixing film 31 is being affected by airflow, extend a time interval for the fixing operations performed for consecutive ones of the recording materials. For example, the CPU 101 can delay the timing at which the second and subsequent recording materials are fed by the feed roller 21 to extend the time interval for the fixing operations.

In both variations, the heater 33 heats the fixing film 31 for a longer period of time before the fixing period, and the possibility of the temperature of the fixing film 31 deviating from the target temperature range during the fixing period is reduced as a result. These variations may be combined with the first embodiment example in any way. For example, in response to a determination that the temperature of the fixing film 31 is being affected by airflow, the CPU 101 may increase the amount of heat generated by the heater 33 per unit of time and also extend the preheating time.

### 4-6. Other Variations

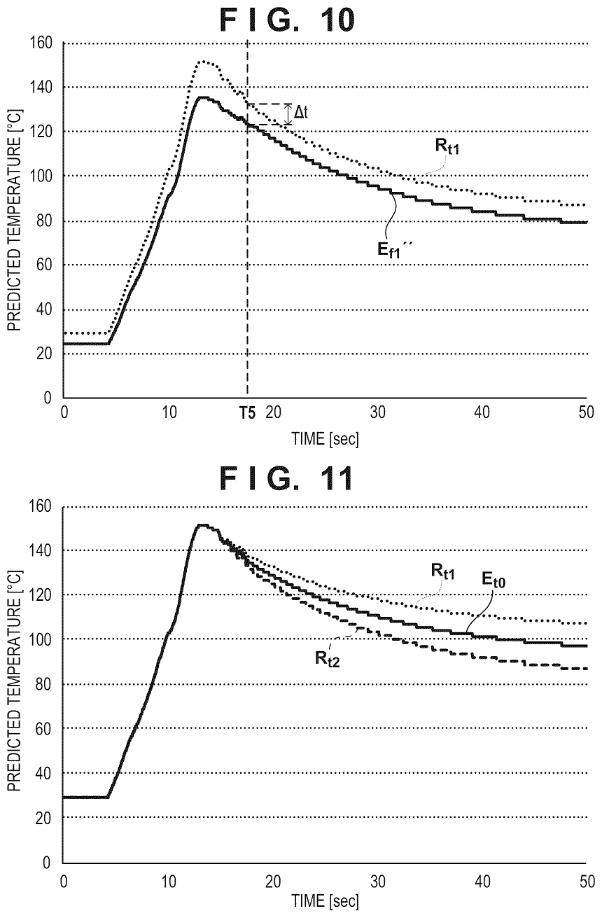

As a further variation, the CPU 101 may correct the predicted temperature of the fixing film 31 such that the difference obtained by subtracting the predicted temperature of the fixing film 31 from the measured temperature of the heater 33 is kept constant. FIG. 10 is a graph for illustrating the correction of the predicted temperature of the fixing film 31 in such a variation. FIG. 10 illustrates a corrected predicted temperature profile E_{f1}″ along with the same measured temperature profile Rₜ₁ of the heater 33 as that illustrated in FIG. 7. Here, by setting the sum of the predicted temperature and an offset Δt as the first threshold, and comparing the measured temperature of the heater 33 with the first threshold, the CPU 101 determines whether the temperature of the fixing film 31 is being affected by airflow. In the example in FIG. 10, the measured temperature of the heater 33, which gradually decreases after the fixing period, converges with the first threshold at time T5. The CPU 101 then uses the value obtained by subtracting the offset Δt from the measured temperature of the heater 33 as the predicted temperature of the fixing film 31. Accordingly, from time T5 on, the predicted temperature profile E_{f1}″ indicates a temperature that is lower than the temperature indicated by the measured temperature profile Rₜ₁ by Δt. The amount of heat generated by the heater 33 per unit of time at the start of the next round of image-forming operations can also be increased by using the predicted temperature corrected in this manner.

As another variation, the CPU 101 may correct the predicted temperature of the fixing film 31 on the basis of the ambient temperature measured by a temperature sensor (e.g., a thermistor) additionally provided in the image-forming apparatus 1. For example, the CPU 101 may correct the predicted temperature to a value equal to the ambient temperature when the predicted temperature of the fixing film 31 is lower than the ambient temperature. Normally, the temperature of the fixing film 31 is not expected to be lower than the ambient temperature, regardless of whether there is an effect of airflow or not. If the predicted temperature of the fixing film 31 is lower than the ambient temperature, that value is therefore likely to be an anomalous value. Accordingly, image defects caused by prediction error can be reduced by correcting the predicted temperature of the fixing film 31 to a value that is at least greater than or equal to the ambient temperature.

### 4-7. Summary of First Embodiment Example

According to the first embodiment example described above, a controller (e.g., the control unit 100) of an image-forming apparatus controls the supply of power to a heating body using the measured temperature of the heating body measured by a measurement circuit (the thermistor 40). Typically, the supply of power to the heating body may be controlled on the basis of a predicted temperature of a fixing member (the fixing film 31) predicted using the measured temperature of the heating body. When it is determined, on the basis of the measured temperature of the heating body, that the temperature of the fixing member is being affected by airflow, the controller changes at least one control condition for controlling the fixing of the toner image to the recording material by the fixing apparatus. Specifically, when the measured temperature of the heating body is lower than a first threshold that is based on the predicted temperature of the fixing member, the controller determines that the temperature of the fixing member is being affected by airflow, and changes the at least one control condition such that the temperature of the fixing member during a fixing period falls within a target temperature range. Changing the control conditions flexibly in this manner reduces the occurrence of image defects in the fixing apparatus caused by external disturbances. For example, even if the temperature of the fixing member has been affected by airflow and has dropped beyond the degree assumed by a prediction model, the effects of the airflow can be canceled out by changing the control conditions, and the fixing operations can be performed with the fixing member heated to an appropriate temperature.

### 5. Second Embodiment Example

### 5-1. Determining Effect of Airflow

Similar to the first embodiment example, in the second embodiment example, the CPU 101 derives the predicted temperature of the fixing film 31 by inputting the measured temperature of the heater 33 to the above-described prediction model. The temperature of the heater 33 is measured by the thermistor 40. The CPU 101 controls the supply of power from the power source 50 to the heater 33 such that the temperature of the fixing film 31 falls within the target temperature range during the fixing period using the predicted temperature of the fixing film 31 as a control variable for feedback control.

The CPU 101 monitors the measured temperature of the heater 33 to determine whether the temperature of the fixing film 31 is being affected by airflow. Specifically, in the second embodiment example, the CPU 101 determines that the temperature of the fixing film 31 is being affected by airflow when the decreasing speed of the measured temperature of the heater 33 after the operations by the fixing apparatus 30 end is faster than a second threshold. The memory 103 stores the second threshold. The second threshold may be a fixed value which does not depend on time, or may be a value that changes depending on the time that has passed from the end of the fixing operations or image-forming operations.

FIG. 11 is a graph for illustrating the determination of the effect of airflow that is based on the decreasing speed of the measured temperature. FIG. 11 illustrates a threshold profile Eₜ₀ along with the same measured temperature profiles Rₜ₁ and Rₜ₂ of the heater 33 as those indicated in FIG. 7. As described above, the measured temperature profile Rₜ₁ represents a temporal change in the measured temperature of the heater 33 when no effect of airflow is present (e.g., assuming natural cooling). The measured temperature profile Rₜ₂ represents a temporal change in the measured temperature of the heater 33 when the effect of airflow is present. Comparing the measured temperature profiles Rₜ₁ and Rₜ₂, it can be seen that the temperature of the heater 33, which reaches a peak during the fixing period, decreases at a faster rate after the end of the fixing operation when the effect of airflow is present than when no effect of airflow is present. The threshold profile Eₜ₀ indicates a value between values indicated by the two measured temperature profiles Rₜ₁ and Rₜ₂ at each time (e.g., an average value). The second threshold described above may be determined in advance by determining the slope of the threshold profile Eₜ₀, and may be stored in the memory 103 in association with elapsed time from the end of the operations.

### 5-2. Changing Control Conditions

In the present embodiment example too, when it is determined that the temperature of the fixing film 31 is being affected by airflow, the CPU 101 changes at least one control condition for controlling the fixing by the fixing apparatus 30. The change in the control conditions here may be one or a combination of two or more of the several methods described in relation to the first embodiment example. For example, the CPU 101 may increase the amount of heat generated by the heater 33 per unit of time by one or more of (i) lowering the control variable of the feedback control (the predicted temperature of the fixing film 31), (ii) raising a target value, and (iii) increasing a gain. The CPU 101 may alternatively extend the preheating time from when the supply of power to the heater 33 is started to when the recording material reaches the fixing nip Nf. The CPU 101 may alternatively extend the time interval for fixing operations performed for consecutive ones of the recording materials when toner images are successively formed on a plurality of recording materials. In this manner, the temperature of the fixing film 31 rises more rapidly or for a longer period of time, whereby the possibility of the temperature of the fixing film 31 deviating from the target temperature range during the next fixing period is reduced.

### 5-3. Flow of Processing

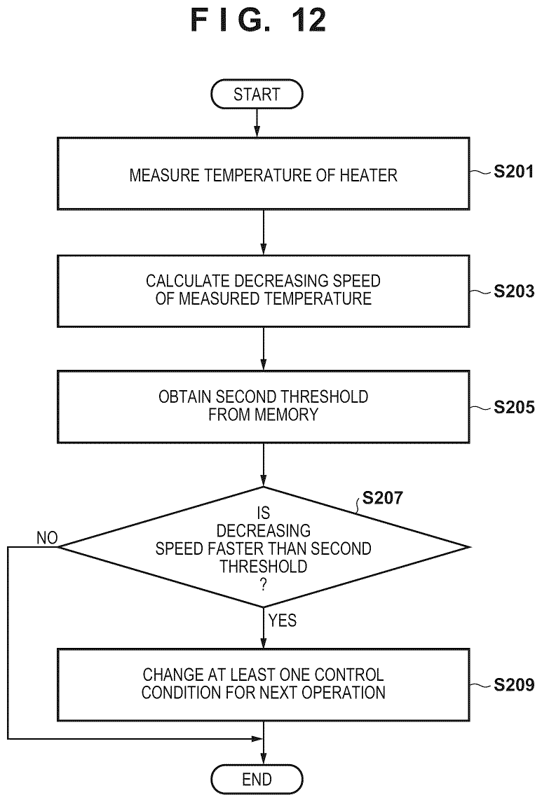

FIG. 12 is a flowchart illustrating an example of the flow of temperature monitoring processing according to the second embodiment example. The temperature monitoring processing illustrated in FIG. 12 can be executed iteratively by the control unit 100 in a constant monitoring cycle during a period when the image-forming apparatus 1 is not performing image-forming operations, for example.

First, in step S201, the control unit 100 causes the thermistor 40 arranged near the heater 33 to measure the temperature of the heater 33, and obtains the measured temperature. Next, in step S203, the control unit 100 calculates the decreasing speed of the measured temperature of the heater 33. Then, in step S205, the control unit 100 obtains, from the memory 103, the second threshold (fixed or time-dependent) for determining the effect of airflow.

Next, in step S207, the control unit 100 determines whether the decreasing speed of the measured temperature of the heater 33 calculated in step S203 is faster than the second threshold obtained in step S205. If the decreasing speed of the measured temperature is determined to be faster than the second threshold, in step S209, the control unit 100 changes at least one control condition to be used during the next round of fixing operations. Step S209 is skipped if the decreasing speed of the measured temperature is determined not to be faster than the second threshold.

Note that if the control conditions to be used during the next round of fixing operations have been changed once in step S209, the temperature monitoring processing in the subsequent monitoring cycles may be omitted, and the post-change control conditions may be kept until the next round of fixing operations.

### 5-4. Comparative Test

To confirm the effects of the second embodiment example, a comparative test was performed to compare the fixing performance in the second embodiment example and two comparison examples. The configurations of the members of the fixing apparatus 30 in the second embodiment example and the comparison examples are the same as the configurations described in relation to the comparative tests in the first embodiment example.

In the second embodiment example, when it is determined that no effect of airflow is present, the target temperature is set to 155° C. when the next round of operations is started 20 minutes after the end of the previous round of operations, and to 165° C. when the next round of operations is started 30 minutes after that end. In addition, when it is determined that the effect of airflow is present, the target temperature is set to 165° C. when the next round of operations is started 20 minutes after the end of the previous round of operations, and to 170° C. when the next round of operations is started 30 minutes after that end.

On the other hand, in the two comparison examples (a third comparison example and a fourth comparison example), the effect of airflow is not determined. In the third comparison example, the target temperature is set to 155° C. when the next round of operations is started 20 minutes after the end of the previous round of operations, and to 165° C. when the next round of operations is started 30 minutes after that end. In the fourth comparison example, the target temperature is set to 165° C. when the next round of operations is started 20 minutes after the end of the previous round of operations, and to 175° C. when the next round of operations is started 30 minutes after that end. The target values of the temperature control under the test conditions of the second embodiment example, the third comparison example, and the fourth comparison example are summarized in the following Table 3.

TABLE 3

| | | TARGET | | TARGET | |
|---|---|---|---|---|---|
| | | TEMPERATURE | | TEMPERATURE | |
| | | WITHOUT | | WITH | |
| | DETER- | EFFECT OF | | EFFECT OF | |
| | MINATION | AIRFLOW [° C.] | | AIRFLOW [° C.] | |
| | OF EFFECT | AFTER | AFTER | AFTER | AFTER |
| | OF AIRFLOW | 30 MIN | 20 MIN | 30 MIN | 20 MIN |
| SECOND | YES | 165 | 155 | 170 | 165 |
| EMBODIMENT | | | | | |
| EXAMPLE | | | | | |
| THIRD | NO | 165 | 155 | (165) | (155) |
| COMPARISON | | | | | |
| EXAMPLE | | | | | |
| FOURTH | NO | 175 | 165 | (175) | (165) |
| COMPARISON | | | | | |
| EXAMPLE | | | | | |

For each of the second embodiment example, the third comparison example, and the fourth comparison example, the temperature of the fixing film 31 was changed according to the following four scenarios, and the fixing performance of each was then subjectively evaluated:
C) Natural cooling for 20 minutes after printing an image on 10 sheets of recording material
D) Natural cooling for 30 minutes after printing an image on 10 sheets of recording material
E) Cooling the fixing film 31 with airflow from an external fan for 20 minutes after printing an image on 10 sheets of recording material
F) Cooling the fixing film 31 with airflow from an external fan for 30 minutes after printing an image on 10 sheets of recording material

The following Table 4 lists the evaluation results. The meanings of the circles and the Xs are the same as in Table 2.

TABLE 4

| | WITHOUT EFFECT | | | | WITH EFFECT | | | |
|---|---|---|---|---|---|---|---|---|
| | OF OUTSIDE AIR | | | | OF OUTSIDE AIR | | | |
| | SCENARIO C | | SCENARIO D | | SCENARIO E | | SCENARIO F | |
| | FIXING | HOT | FIXING | HOT | FIXING | HOT | FIXING | HOT |
| | DEFECT | OFFSET | DEFECT | OFFSET | DEFECT | OFFSET | DEFECT | OFFSET |
| SECOND | ◯ | ◯ | ◯ | ◯ | ◯ | ◯ | ◯ | ◯ |
| EMBODIMENT | | | | | | | | |
| EXAMPLE | | | | | | | | |
| THIRD | ◯ | ◯ | ◯ | ◯ | X | ◯ | X | ◯ |
| COMPARISON | | | | | | | | |
| EXAMPLE | | | | | | | | |
| FOURTH | ◯ | X | ◯ | X | ◯ | ◯ | ◯ | ◯ |
| COMPARISON | | | | | | | | |
| EXAMPLE | | | | | | | | |

In the third comparison example, image defects did not occur in scenarios C and D, which are the cases of no effect of outside air being present, but fixing defects did occur in scenarios E and F, which are the cases of the effect of outside air being present. In the fourth comparison example, image defects did not occur in scenarios E and F, which are the cases of the effect of outside air being present, but hot offset did occur in scenarios C and D, which are the cases of no effect of outside air being present.

In contrast, in the second embodiment example, no image defects occurred in any of the scenarios C to F. The reason why hot offset did not occur in scenarios C and D is thought to be that the predicted temperature of the fixing film 31 at the start of image-forming operations had no error relative to the actual temperature (whereas, in the fourth comparison example, the target temperature was too high). The reason why fixing defects did not occur in scenarios E and F is thought to be that the predicted temperature at the start of operation was higher than the actual temperature, but the amount of heat generated by the heater 33 was increased in response to the determination that the effect of outside air was present (whereas, in the third comparison example, the amount of heat generated was insufficient).

### 5-5. Summary of Second Embodiment Example

According to the second embodiment example described above, a control unit (e.g., the control unit 100) of an image-forming apparatus controls the supply of power to a heating body using the measured temperature of the heating body measured by a measurement unit (the thermistor 40). When it is determined, on the basis of the measured temperature of the heating body, that the temperature of the fixing member is being affected by airflow, the control unit changes at least one control condition for controlling the fixing of the toner image to the recording material by the fixing apparatus. Specifically, when the decreasing speed of the measured temperature of the heating body after the operations by the fixing apparatus end is faster than a second threshold, the control unit determines that the temperature of the fixing member is being affected by airflow, and changes the control conditions such that the temperature of the fixing member during the fixing period falls within a target temperature range. Changing the control conditions flexibly in this manner reduces the occurrence of image defects in the fixing apparatus caused by external disturbances. For example, even if the temperature of the fixing member has been affected by airflow and has dropped beyond the degree assumed by a prediction model, the effects of the airflow can be canceled out by changing the control conditions, and the fixing operations can be performed with the fixing member heated to an appropriate temperature.

### 6. Other Embodiments

Embodiment(s) of the technology according to the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the technology according to the present disclosure has been described with reference to exemplary embodiments, it is to be understood that it is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-078790, filed on May 14, 2024 which is hereby incorporated by reference herein in its entirety.

What is claimed is:

1. An image-forming apparatus comprising:
a fixing apparatus configured to fix a toner image onto a recording material; and
a controller configured to control fixing of the toner image onto the recording material by the fixing apparatus in accordance with at least one control condition,
wherein the fixing apparatus includes:
a fixing member capable of rotating;
a pressurizing member configured to, along with the fixing member, nip and convey the recording material;
a heating body configured to heat the fixing member; and
a measurement circuit configured to measure a temperature of the heating body, and
the controller is configured to:
control a supply of power to the heating body using a measured temperature of the heating body measured by the measurement circuit; and
change the at least one control condition in a case where the measured temperature is lower than a predicted temperature of the fixing member.

2. The image-forming apparatus according to claim 1,
wherein the controller is configured to determine the predicted temperature of the fixing member using the measured temperature of the heating body.

3. The image-forming apparatus according to claim 2,
wherein the controller is configured to derive the predicted temperature by inputting the measured temperature into a predetermined prediction model.

4. The image-forming apparatus according to claim 1,
wherein the measurement circuit includes a thermistor arranged near the heating body, and
the fixing apparatus does not include a temperature measurement circuit, aside from the measurement circuit, for predicting a temperature of the fixing member.

5. The image-forming apparatus according to claim 1,
wherein changing the at least one control condition includes increasing an amount of heat generated by the heating body per unit of time.

6. The image-forming apparatus according to claim 1,
wherein changing the at least one control condition includes extending a time from when the supply of power to the heating body starts to when the recording material reaches a nip between the fixing member and the pressurizing member.

7. The image-forming apparatus according to claim 1,
wherein changing the at least one control condition includes, in a case where toner images are formed successively on a plurality of recording materials,
extending a time interval of a fixing operation performed for consecutive ones of the recording materials.

8. The image-forming apparatus according to claim 1,
wherein the fixing member is a flexible endless film.

9. The image-forming apparatus according to claim 8,
wherein the heating body is arranged in a space surrounded by the film,
and nips the film at a nip part between the heating body and the pressurizing member, and
the toner image on the recording material is heated through the film at the nip part.
